(19) United States
(12) Patent Application Publication
(10) Pub. No.: US 2004/0100968 A1
(43) Pub. Date: May 27, 2004

(54) Multiprotocol label switching device with distributed forward engines and method thereof

(75) Inventor: Wook Kim, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., kYUNGKI-DO (KR)

(21) Appl. No.: 10/641,701

(22) Filed: Aug. 15, 2003

(30) Foreign Application Priority Data
Nov. 25, 2002 (KR) 2002-0073437

(51) Int. Cl. H04L 12/56

(52) U.S. Cl. 370/395.5; 370/395.71

(57) ABSTRACT

A multiprotocol label switching device with a distributed forward engine, in which inputted traffic is transferred to its destination by passing once via a switch. Thereby, waste of switch resources is prevented and improved performance of the device is achieved providing stable operation. The multiprotocol label switching device comprises: an interface module in which forward engines for packet input/output are distributed and installed; a controller for allocating VPIs between the forward engines, storing/managing the information on the VPIs; and a switch for switching a packet between the forward engines within the device. The controller allocates the VPIs to the forward engines according to an expression: VPI number=(self forward engine number+relative forward engine number) % total number of the forward engines. The controller generates, stores, extracts or deletes internal connection information based on the VPI information. In addition, the controller transfers the internal connection information to the forward engine. The forward engine changes the internal connection information according to the received internal connection information and performs connection operation.

### PRIORITY

This application claims priority to an application entitled “Multi Protocol Label Switching Apparatus with Distributed Forward Engine and Method Thereof” filed in the Korean Intellectual Property Office on Nov. 25, 2002 and assigned the Serial No. 2002-0073437, the contents of which are incorporated herein by reference.

### BACKGROUND OF THE INVENTION

1. Field of the Invention

The present invention relates to a multiprotocol label switching (MPLS) system, and more particularly, to a MPLS device with distributed forward engines and method thereof.

2. Description of the Related Art

MPLS network routes Internet protocol (IP) packets in network input/output operations and performs high speed switching using labels at the center of the network to improve the performance of an IP network. The MPLS network sets a label switched path (LSP) that is a logic channel in a non-connected type IP network, so that the non-connected type IP network may act as a connected type IP network.

In other words, the MPLS is a transfer mechanism for providing flexibility and expandability of IP as well as the quality of service (QoS) of asynchronous transfer mode (ATM) or frame relay. The MPLS has a structure suitable for providing an improved IP service in an IP network. Recently that has been a hotly discussed issue on the Internet, that discussion including mechanisms of virtual private network (VPN), Voice over IP (VoIP), web hosting, electronic commerce and traffic engineering.

The basic operation of the MPLS is to forward messages by combining various control modules and carrying out label swapping. The control modules can be a basic unicast or singlecast routing module, a traffic engineering module or a VPN module. In such an MPLS network, the LSP is set using a label distribution protocol (LDP) that is a connection establishment protocol of the MPLS. The packet is transferred effectively and speedily by an LSP using a short header named “a label”.

The components of the MPLS network include a label edge router (LER) and a label switched router (LSR). The label edge router (LER), is located at the border of the existing network. The LER adds labels to existing IP packets to create MPLS packets, thereby allowing entry of such IP packets into the MPLS network. Also, the LER performs the function of terminating the MPLS network and proceeding from the MPLS network to other existing networks. The LSR performs a label swapping.

The entry LER analyzes the headers, that include IP addresses of the packets that are transferred from non-MPLS networks and determines the LSP to which this packet is transferred. Then, the entry LER encapsulates the packets according to the determined LSP, i.e., attachment of a label having a different format according to a link layer. When the labeled packet is received from the LER, the LSR checks only the label, changes the value of the label and transfers the packet to a predetermined exit. The exit LER removes the label from the received packet and transfers the packet to the network external to MPLS network. Similarly, the LER corresponding to an endpoint of the LSP in the MPLS network performs a layer 3 packet forward function and the LSR of a core of the LSP performs a layer 2 packet forward function.

FIG. 1a illustrates an example of the schematic structure of a general LER. Referring to FIGS. 1a and 1b, the LER 100 includes a plurality of ATM interface modules (AIMs) 110 through which message packets are inputted or outputted, a routing processor 120 for managing all operations of a router, and a switch fabric 130 used when a message packet is switched to a specific port in the router 120. Such an LER 100 has a centralized structure wherein a forward engine (FE) 112 is installed in the predetermined one of the existing AMMs 110.

However, as described above, the conventional MPLS device LER has the centralized FE 112. Thus, as shown in FIG. 1b, in order that the traffic introduced into the device can go to a destination, the traffic is transferred through a switch 130 to the AIM 110 with the FE 112 and then looks up a forwarding table of the FE 112. Then, the connection should be established to again proceed through the switch 130 to the AIM heading for the destination 114. As descried above, the conventional MPLS device requires switch connections internally twice for one connection. As the number of connections increases, the waste of the switch resources is created.

### SUMMARY OF THE INVENTION

Accordingly, the present invention is directed to a multiprotocol label switching (MPLS) device with distributed forward engines and method thereof, in which inputted traffic is transferred to its destination by passing via a switch one time to prevent waste of switch resources. Therefore, it is possible to improve performance of the message routing device while allowing stable operation of the device.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims thereof as well as the appended drawings.

To achieve these objects and other advantages in accordance with the purpose of the invention, as embodied and broadly described herein, there is provided a multiprotocol label switching device with distributed forward engines, which comprises: an interface module in which forward engines for packet input or output are distributed and installed, the forward engines changing an internal connection information and performing a connection operation according to a received internal connection information; a controller for allocating virtual path identifiers (VPIs) between the forward engines, storing and managing the information on the virtual path identifiers, managing the internal connection information based on the VPI information, and providing the forward engines with the managed internal connection information; and a switch for switching a packet between the forward engines within the device.

In addition, the controller allocates the VPIs to the forward engines according to an expression: VPI number=(self forward engine number+relative forward engine number) % total number of the forward engines. The internal connection information is generated, stored, extracted or deleted based on the VPI information. The internal connection information is transferred to the forward engine. Accordingly, the forward engine changes the internal connection information according to the received internal connection information and performs connection operation.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1a and 1b illustrate examples of a schematic structure of the conventional label edge router (LER);

FIGS. 2a and 2b illustrate a schematic overall configuration of a multiprotocol label switching (MPLS) device with distributed forward engines according to an embodiment of the present invention;

FIG. 3 illustrates a flowchart of management operation of forward engine internal connection information of the MPLS device with distributed forward engines according to an embodiment of the present invention;

FIG. 4 illustrates an example of virtual path identifier (VPI) number allocation table between respective forward engines in the distributed forward engines according to an embodiment of the present invention;

FIG. 5 illustrates an example of Virtual Path (VP) full mesh table in the distributed forward engines according to an embodiment of the present invention;

FIG. 6 illustrates a status of VP full mesh connection table between respective forward engines in the distributed forward engines according to an embodiment of the present invention;

FIG. 7 illustrates an example of VPI number allocation table between general forward engines;

FIG. 8 illustrates a status of VP full mesh connection between general forward engines;

FIG. 9 illustrates an example of connection status between respective forward engines, which explains internal connection information generation according to a label switched path (LSP) routing in the distributed forward engines according to an embodiment of the present invention; and

FIG. 10 illustrates an example of connection status between respective forward engines, which explains forwarding table (FT) and merging table (MT) for internal connection between respective forward engines in the distributed forward engines according to an embodiment of the present invention.

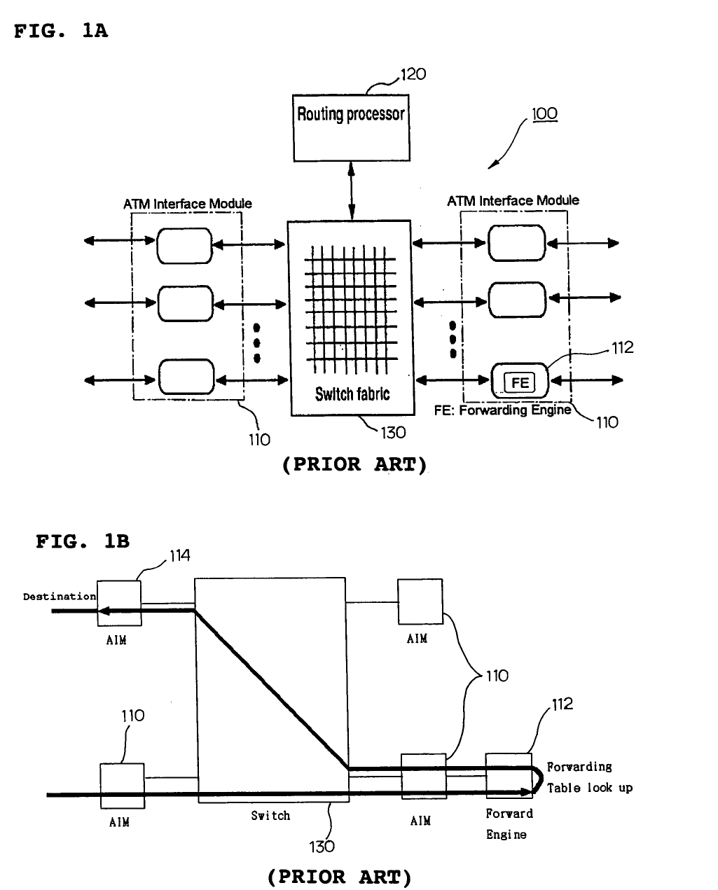

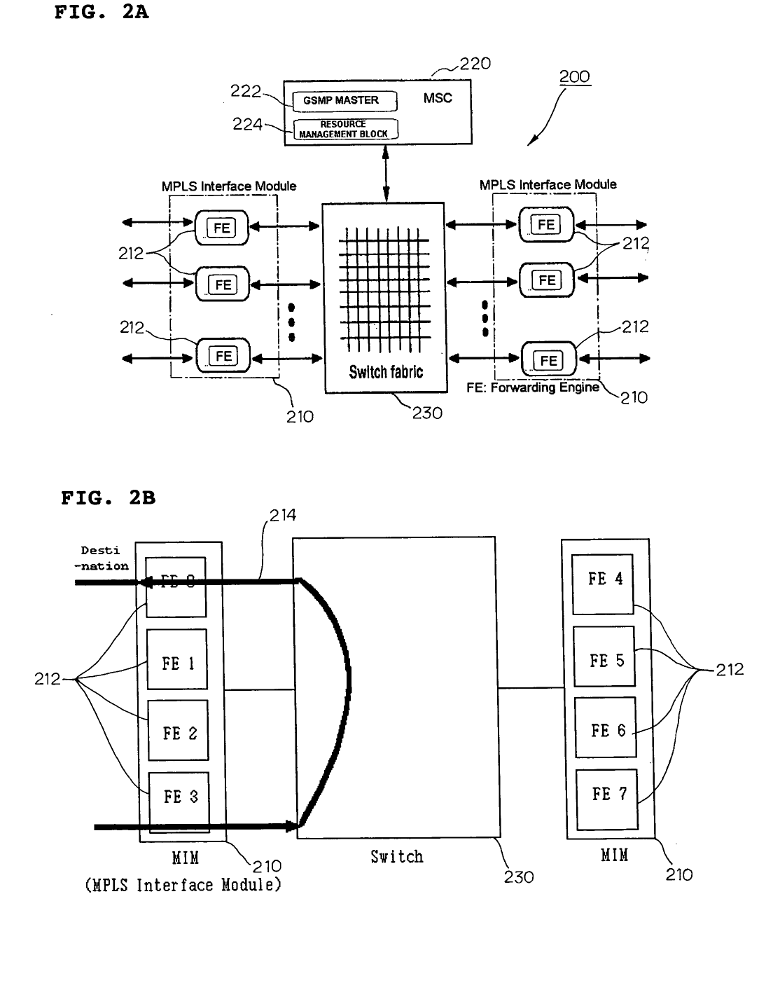

### DETAILED DESCRIPTION OF THE INVENTION

Reference will now be made in detail to the preferred embodiments of the present invention, examples of which are illustrated in the accompanying drawings. It will be apparent to those skilled in the art that various modifications and variations can be made in the present invention. Thus, it is intended that the present invention covers the modifications and variations of this invention within the scope of the present invention.

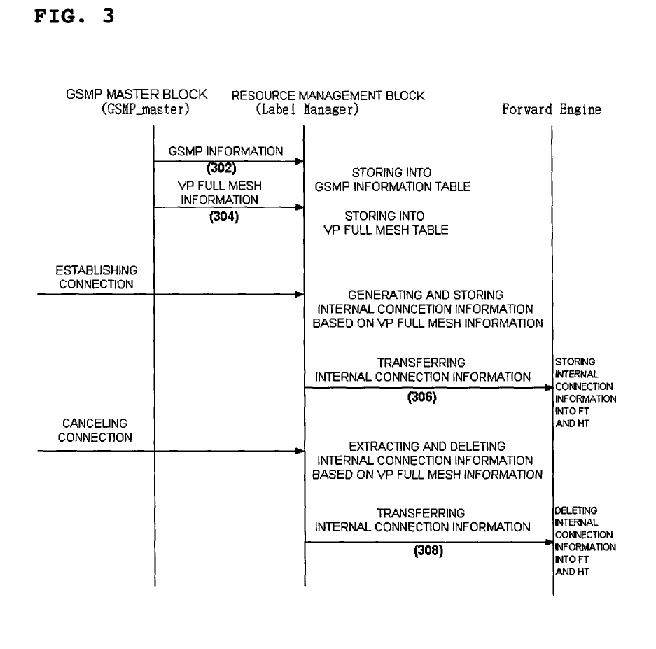

FIGS. 2a and 2b illustrate a schematic overall configuration of a MPLS device with distributed forward engine i.e., an LER, according to an embodiment of the present invention. Referring to FIG. 2, the LER includes an MPLS interface module (MIM) 210 in which the forward engines (FEs) 212 receiving and sending message packets are distributed and installed throughout MIM 210. An MPLS service controller (MSC) 220 for allocating a general switch management protocol (GSMP) information and virtual path identifiers (VPIs) between the respective FEs 212 and storing/managing the information thereon, and a switch fabric 230 used when a packet is switched to a specific FE 212 within the router 200.

As described above, since the LER has distributed FEs 212, the LER according to the present invention can send the received message packet traffic to its destination FE 212 via the switch 230 only once, as shown in FIG. 2b, thereby reducing waste of switch resources as compared with the conventional prior art.

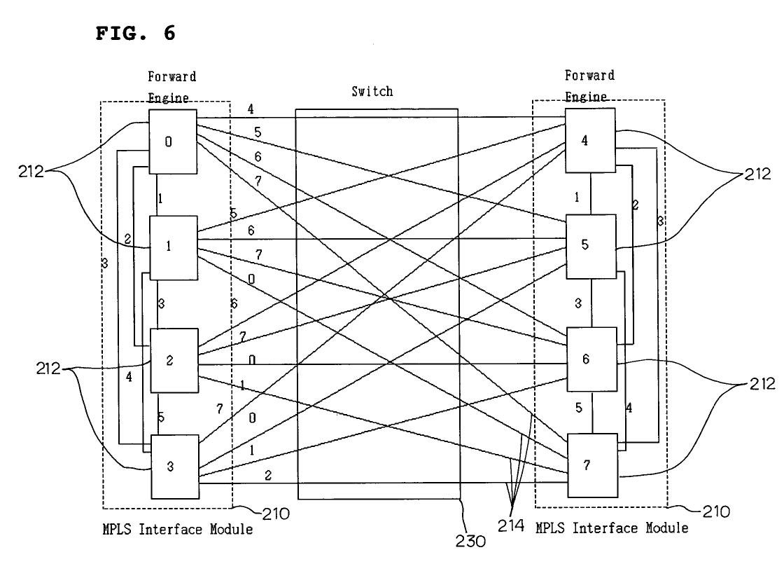

The detailed description of the LER's behavior will be made with reference to the accompanying drawings. As an example, the LER of the present invention having eight FEs 212 will be described. In addition, VP full mesh connection of FIG. 5 will be explained.

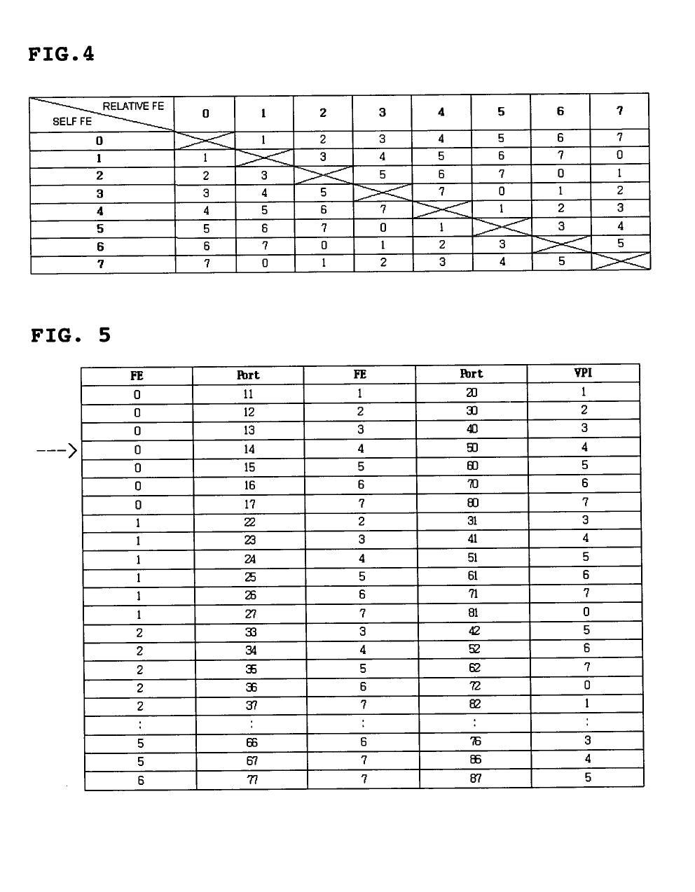

FIG. 3 illustrates a flowchart of management operation of forward engine 212 (FIG. 2b) internal connection information in the LER having the distributed FEs 212 according to an embodiment of the present invention. Referring to FIG. 3, an initialization of the MSC 220 of the LER according to the present invention is performed in step 302. GSMP master 222 allocates GSMP information shown in the table depicted in FIG. 4. Then, at the step 304, the GSMP master 222 performs VP full mesh connection of FIG. 5, an example of such connections is presented in a table in FIG. 5, between the FEs 212. GSMP slave process receives information on the VP full mesh connection and reports the full mesh connection information (VP full mesh table) to the resource management block also called label manager 224. The resource management block 224 stores the full mesh connection information (VP full mesh table). As shown in FIGS. 4 and 6, the VPI is an independent number that is distinguished from the relative FE 212 within the respective FEs 212 in order to distinguish connections between the FEs 212. FIG. 6 shows a status of VP full mesh connection between the respective FEs 212 according to the present invention.

To allocate the VPI number distinguished from the relative FE 212 within the respective FEs 212, the present invention uses the following expression:

VPI number=(self FE number+relative FE number) % total number of FEs.

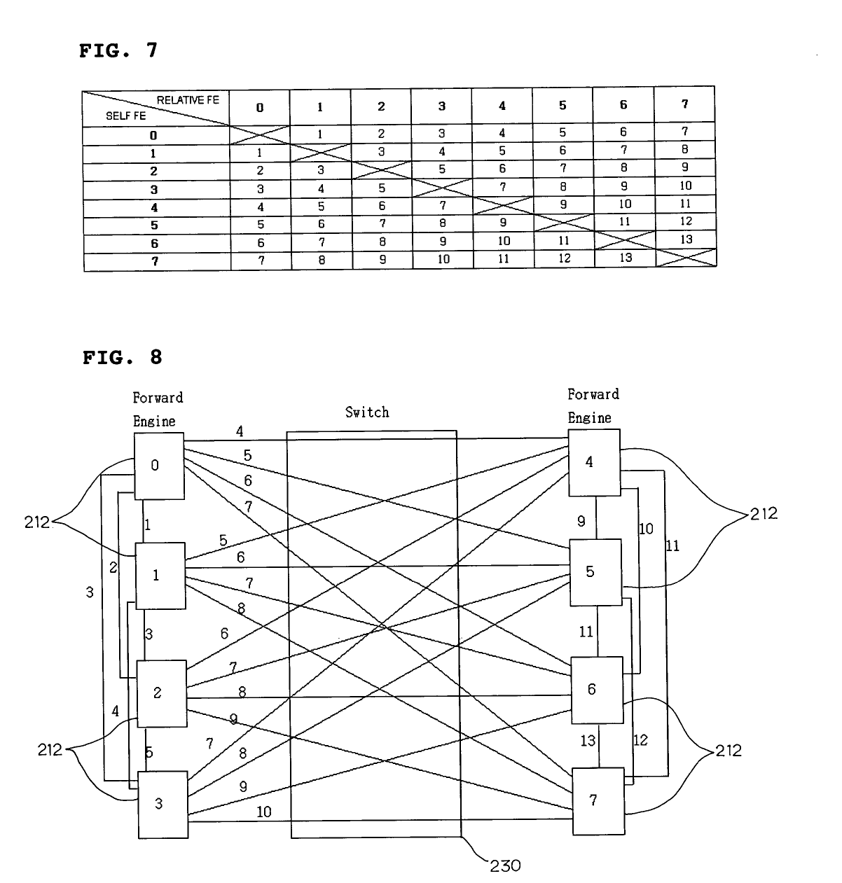

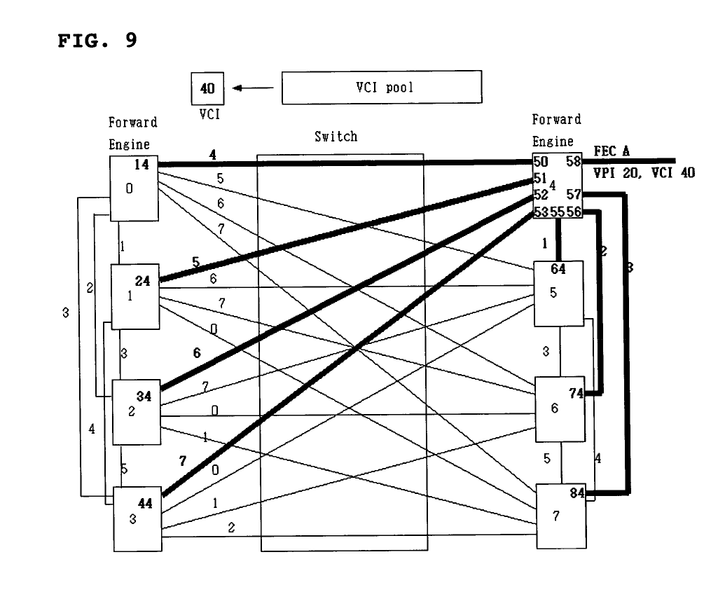

In other words, each VPI number is a remainder obtained by adding the self FE number to the relative FE number and then dividing the added result by total number of FEs. Since the number of the required VPI numbers is the total number of FEs as stated above, the allocation method of VPI number according to the present invention can more effectively use the VPI resources compared with a case of the widely used expression: VPI number=self FE number+relative FE number. In other words, in the case of using the above conventional method, the number of required VPIs is [(total number of FEs−1)+(total number of FEs−2)] as shown in FIGS. 7 and 8. For example, in a case where eight FEs 212 are used, the number of required VPIs is 13. In comparison with the conventional method, however, the VPI number allocation method of the present invention can more effectively use the VPI resources (i.e., about 50% compared with that of the conventional method), resulting in a reduction of the VPI resources expenditure.

As described above, the full mesh connection information (VP full mesh table) shown in FIG. 5 is generated after VPI allocation. Referring to the entry in the table shown in FIG. 5 identified by an arrow, for example, the port 14 of the FE number 0 is connected to the port 50 of the FE number 4 and the VPI number is 4.

Referring back to FIG. 3, in establishing the connection, the resource management block 224 of MSC 220 generates and stores the internal connection information based on the VP full mesh information and transfers the respective FE internal connection information in step 306. Accordingly in response, the FEs 212 store the internal connection information into a forwarding table (FT) and a merging table (MT).

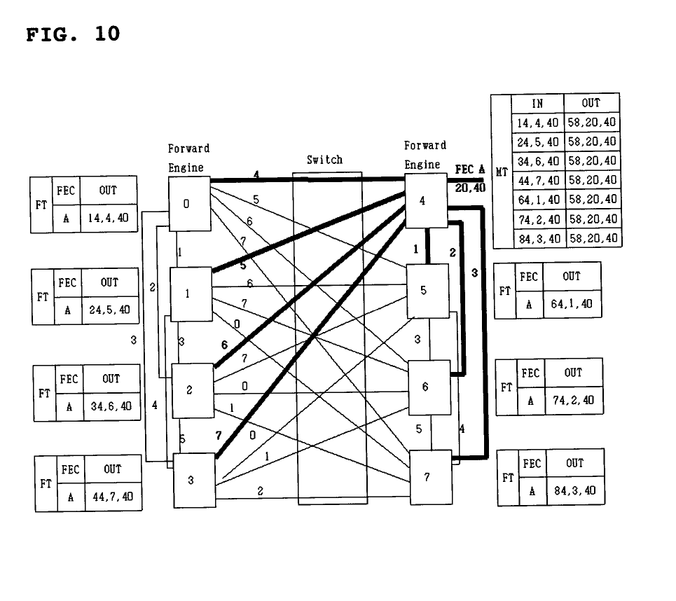

In other words, after completing the VP full mesh connection between the FEs 212, if the VP full mesh connection of the LER is established like the LSP, a connection path to the LSP should be made to another FE 212 of the same LER. For this, the connection information (port, VPI and VCI) between the FEs 212 is generated by allocating any VCI number available from a virtual channel identifier (VCI) pool to the previously generated VP full mesh information, referring to the VP full mesh table. Referring to FIG. 9, if the FE 212 connected to a specific destination (FEC) A is FE 212 number 4, assignment 40 is allocated to the VIC number and the ports VPI and VCI for connecting each FE 212 and destination are generated in the FE 212 number 4.

As described above, the generated connection information as stated above is stored in the forwarding table (FT) of the FE, and if the destination of the received message packet is matched to the connection information, the received message packet is transferred to the corresponding connection path. In order to connect other FEs 212 to the LSP, the FE 212 connected to the LSP maps the FE connection information to the LSP connection information in the merging table (MT) and performs merging function to allow the packets received from the FEs 212 to go through one LSP. Referring to FIG. 10, for example, if a packet whose destination is A is received from the FE 212 number 0, the packet is transferred to a proper connection path (i.e., port 14, internal VPI 4, VCI 40) with reference to the FT. Thus, the packet is transferred to the FE 212 number 4. Referring to the MT, the FE 4 transfers the corresponding packets delivered from each FE to a proper path (i.e., port 58, external VPI 20, VCI 40) to allow the packets to be transferred to the corresponding LSP.

Referring back to FIG. 3, when a connection is released, the resource management block 224 of the MSC 220 extracts/deletes the internal connection information based on the VP full mesh information, so that each FE internal connection information is transferred in step 308. Thus, the FE 212 deletes it from the forwarding table (FT) and the merging table (MT).

Structure and operation according to the embodiment of the present invention as described above may be achieved. It will be apparent to those skilled in the art that various modifications and variations can be made in the present invention. Thus, it is intended that the present invention covers the modifications and variations of this invention and they come within the scope of the appended claims and their equivalents.

As described above, the multiprotocol label switching (MPLS) device of the present invention employs the distributed forward engines, so that the inputted traffic can be transferred to its destination by passing via the switch one time. Thus, a waste of switch resources can be prevented thereby improving the performance and achieving stable operation of the device.

What is claimed is:

1. A multiprotocol label switching device including one or more distributed forward engines, said device comprising:
at least one interface module having a plurality of forward engines distributed and installed therein, each of the plurality of forward engines changing internal connection information to received internal connection information and performing a connection operation;
a controller for allocating virtual path identifiers (VPIs) between the plurality of forward engines, according to an expression: VPI number=(self forward engine number+relative forward engine number) % total number of the forward engines, said controller storing and managing information on virtual path identifiers, managing internal connection information based on VPI information, and providing the plurality of forward engines with managed internal connection information; and
a switch for switching a message packet between the plurality of forward engines.

2. A method for managing internal connection information in a multiprotocol label switching device with an interface module in which the forward engines for packet input/output are distributed and installed, comprising the steps of:
(a) allocating general switch management protocol (GSMP) information and virtual path identifiers (VPIs) between forward engines according to an expression: VPI number=(self forward engine number+relative forward engine number) % total number of the forward engines;
(b) performing virtual path (VP) full mesh connections based on the allocated GSMP information and generating the VP full mesh connection information;
(c) generating and storing the internal connection information between the FEs based on the VP full mesh information when establishing connections, and transferring the internal connection information to the respective forward engines; and
(d) extracting and deleting the stored internal connection information based on the VP full mesh information when releasing connections, and transferring the internal connection information to the respective forward engines.

3. A method for managing internal connection information in a multiprotocol label switching (MPLS) device including at least one interface module, the MPLS device including a plurality of forward engines used for packet input/output, the plurality of forward engines being distributed and installed throughout said at least one interface module, said method comprising the steps of:
allocating general switch management protocol (GSMP) information and virtual path identifiers (VPIs) between said plurality of Forward Engines according to an expression: VPI number=(self forward engine number+relative forward engine number) % total number of the forward engines;
performing virtual path (VP) full mesh connections between said plurality of forward engines according to the allocated GSMP information;
generating the internal connection information between the plurality of forward engines based on the VP full mesh information when establishing connections; and
extracting and deleting the stored internal connection information based on the VP full mesh information when releasing connections.

4. The method of claim 5, wherein said step of performing further includes the step of generating the VP full mesh connection information.

5. The method of claim 5, wherein said step of generating further includes the steps of:
storing internal connection information between the plurality of forward engines based on the VP full mesh information; and
transferring the internal connection information to the plurality of forward engines.

6. The method of claim 5, wherein said step of extracting further includes the step of transferring the internal connection information to the plurality of forward engines.
